(19) United States
(12) Patent Application Publication
(10) Pub. No.: US 2014/0018076 A1
(43) Pub. Date: Jan. 16, 2014

(54) METHOD AND APPARATUS FOR BLOCKING HIGH MOBILITY USERS IN WIRELESS NETWORKS

(71) Applicant: QUALCOMM INCORPORATED, San Diego, CA (US)

(72) Inventors: Yan Zhou, San Diego, CA (US); Peerapol Tinnakornsrisuphap, San Diego, CA (US); Mehmet Yavuz, San Diego, CA (US)

(73) Assignee: QUALCOMM Incorporated, San Diego, CA (US)

(21) Appl. No.: 13/786,097

(22) Filed: Mar. 5, 2013

Related U.S. Application Data
(60) Provisional application No. 61/672,227, filed on Jul. 16, 2012.

(51) Int. Cl. H04W 48/04

(52) U.S. Cl. CPC H04W 48/04
USPC 455/436

(57) ABSTRACT

Systems and methods are provided for reporting high mobility user equipment (UE) in a wireless network. This may be achieved, for example, by detecting a high mobility UE at a network node and reporting the high mobility UE in a blocking message to one or more other network nodes.

### CLAIM OF PRIORITY UNDER 35 U.S.C. §119

The present application for Patent claims the benefit of U.S. Provisional Application No. 61/672,227, entitled “METHOD AND APPARATUS FOR BLOCKING HIGH MOBILITY USERS IN WIRELESS NETWORKS” filed Jul. 16, 2012, assigned to the assignee hereof, and expressly incorporated herein by reference.

### FIELD OF DISCLOSURE

This disclosure relates generally to telecommunications, and more particularly to femto cell base station management and the like.

### BACKGROUND

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP) (e.g., 3GPP LTE (Long Term Evolution)/LTE-Advanced), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

To supplement conventional base stations, additional small cell providing nodes can be deployed to provide more robust wireless coverage to mobile devices. For example, wireless relay stations and other small cell providing nodes (e.g., Home NodeBs or Home eNBs, collectively referred to as H(e)NBs, femto nodes, pico nodes, etc.) can be deployed for incremental capacity growth, richer user experience, in-building or other specific geographic coverage, and/or the like. Such small cell providing nodes can be connected to the Internet via a broadband connection (e.g., digital subscriber line (DSL) router, cable or other modem, etc.), which can provide the backhaul link to the mobile operator's network. Thus, for example, the small cells can be deployed in user homes to provide mobile network access to one or more devices via the broadband connection. In dense deployment of small cells, however, high mobility user equipment (UE) can frequently handover among the small cells, which can degrade service quality for the UE.

### SUMMARY

Example embodiments of the invention are directed to systems and methods for reporting high mobility UEs in a wireless network.

In some embodiments, a method is provided for reporting high mobility UEs in a wireless network. The method may comprise, for example: detecting a high mobility UE at a network node; and reporting the high mobility UE in a blocking message to one or more other network nodes.

In other embodiments, an apparatus is provided for reporting high mobility UEs in a wireless network. The apparatus may comprise, for example: at least one processor configured to detect a high mobility UE at a network node and to report the high mobility UE in a blocking message to one or more other network nodes; and memory coupled to the at least one processor.

In still other embodiments, another apparatus is provided for reporting high mobility UEs in a wireless network. The apparatus may comprise, for example: means for detecting a high mobility UE at a network node; and means for reporting the high mobility UE in a blocking message to one or more other network nodes.

In still other embodiments, a computer-readable medium is provided comprising code, which, when executed by a processor, causes the processor to perform operations for reporting high mobility UEs in a wireless network. The computer-readable medium may comprise, for example: code for detecting a high mobility UE at a network node; and code for reporting the high mobility UE in a blocking message to one or more other network nodes.

### BRIEF DESCRIPTION OF THE DRAWINGS

The accompanying drawings are presented to aid in the description of embodiments of the invention and are provided solely for illustration of the embodiments and not limitation thereof.

FIG. 1 is a block diagram of an example wireless communication system for deploying a plurality of femto nodes.

FIG. 2 is a block diagram of an example wireless communication system for detecting and reporting high mobility user equipment (UE).

FIG. 3 is a diagram of an example wireless communication system for propagating blocking messages over a plurality of small cells.

FIG. 4 is a flow chart of an aspect of an example methodology for detecting and reporting high mobility UEs.

FIG. 5 is a flow chart of an aspect of an example methodology for detecting and blocking high mobility UEs.

FIG. 6 is a block diagram of an aspect of a wireless communication system in accordance with various aspects set forth herein.

FIG. 7 is a schematic block diagram of an aspect of a wireless network environment that can be employed in conjunction with the various systems and methods described herein.

FIG. 8 illustrates an example wireless communication system, configured to support a number of devices, in which the aspects herein can be implemented.

FIG. 9 is an illustration of an exemplary communication system to enable deployment of femtocells within a network environment.

FIG. 10 illustrates an example of a coverage map having several defined tracking areas.

### DETAILED DESCRIPTION

Various aspects are now described with reference to the drawings. In the following description, for purposes of explanation, numerous specific details are set forth in order to provide a thorough understanding of one or more aspects. It may be evident; however, that such aspect(s) may be practiced without these specific details.

As described further herein, high mobility user equipment (UE) can be detected and blocked in a small cell network to mitigate degradation in service quality for the UEs. In one example, a central controller for a network of small cells can detect a high mobility UE (e.g., based on access history in the network) and can instruct small cells to block access requests from the UE for at least a period of time. Moreover, the central controller can notify a controller of another network (e.g., of the same or different type) of the high mobility UE. In yet another example, the small cells can detect high mobility UEs, and can notify neighboring small cells of the UEs in a blocking message. The blocking message can be propagated by the neighboring small cells to their own neighboring small cells, etc., throughout the small cell network.

A small cell, as referenced herein, can include a femto node, a pico node, micro node, home NodeB or home evolved NodeB (H(e)NB), relay, and/or other small cell providing node, and can be referred to herein using one of these terms, though use of these terms is intended to generally encompass any of such nodes. In general, a small cell transmits at a relatively low power as compared to a macro base station associated with a wireless wide area network (WWAN). A given small cell may therefore use a smaller scale antenna array, which may be attached to a housing for the base station or to a common mounting platform. As such, the coverage area of the small cell is often substantially smaller than the coverage area of a macro base station. Small cells can accordingly be deployed in user homes, offices, other venues, utility poles, public transit, and/or substantially any area to serve a number of devices.

As used in this application, the terms “component,” “module,” “system,” and the like are intended to include a computer-related entity, such as but not limited to hardware, firmware, a combination of hardware and software, software, or software in execution, etc. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, user equipment (UE), etc. A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, a tablet, a smart book, a netbook, or other processing devices connected to a wireless modem, etc. Various aspects are also described herein in connection with a base station. A base station may be utilized for communicating with wireless terminal(s) and may also be referred to as an access point, a NodeB, evolved NodeB (eNB), or some other terminology.

The term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). Long Term Evolution (LTE) is a release of UMTS that uses E-UTRA, which employs OFDMA on the downlink and SC-FDMA on the uplink. UTRA, E-UTRA, UMTS, LTE/LTE-Advanced and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

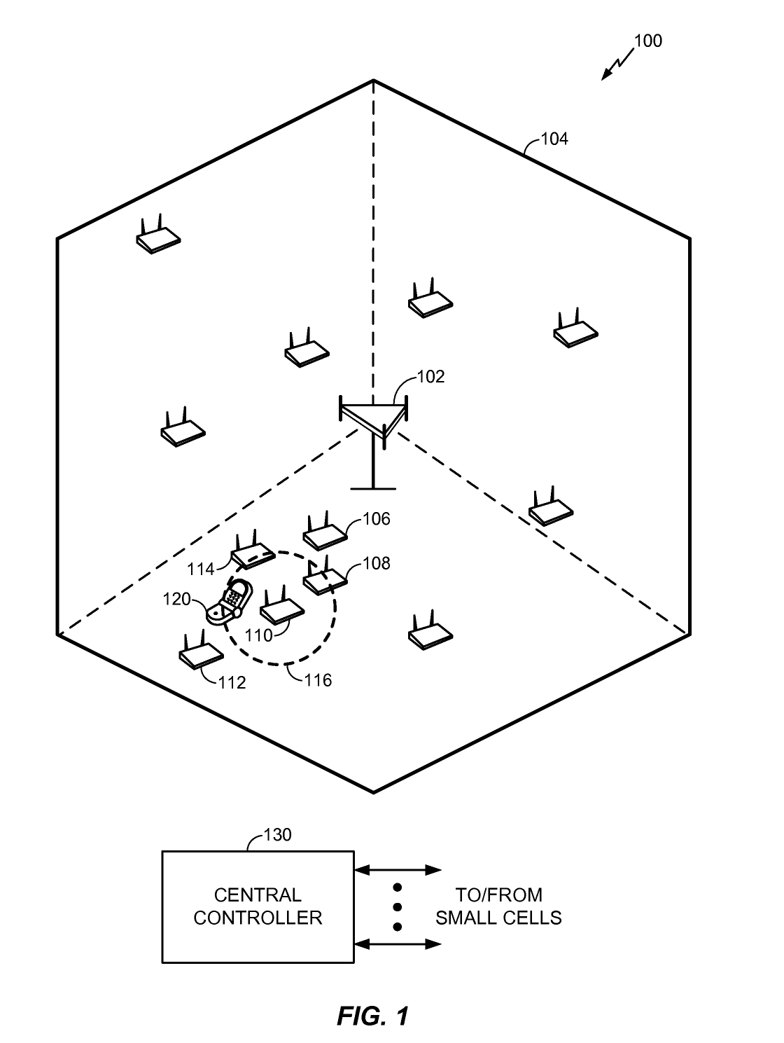

FIG. 1 illustrates an example wireless communication system 100 for deploying a plurality of small cells in a macro coverage cell. System 100 includes a macro base station 102 that provides a coverage area 104 within which UEs can connect with macro base station 102 using wireless communications to receive wireless network access. Within coverage area 104, multiple small cells are deployed as well, including small cells 106, 108, 110, 112, and 114. The small cells can connect with the wireless network via an internet backhaul, as described, and can provide a coverage cell similar to coverage area 116 provided by small cell 110 when powered on and transmitting. A UE 120 is also shown that can be handed over among macro base station 102 and/or small cells in coverage area 104. System 100 also includes a central controller 130 for managing one or more aspects of at least a portion of the small cells within coverage area 104 (e.g., small cells 106, 108, 110, 112, and 114). For example, the central controller 130 can be a femto gateway or similar node that configures one or more parameters for the small cells.

According to an example, UE 120 can move throughout coverage area 104, and can move within and outside of coverage of the small cells 106, 108, 110, 112, and/or 114. Typically, this means that the UE 120 can handover among the small cells when moving within range thereof. Frequent handover can lead to degradation in service quality experienced by the UE 120. Thus, high mobility of UE 120 can be detected, and the small cells 106, 108, 110, 112, 114 and/or other small cells can block access to the UE 120 for at least a period of time or until the occurrence of an event. In one example, this can cause UE 120 to connect to macro base station 102 to receive access for at least the period of time or until the event.

In one example, central controller 130 can detect high mobility at UE 120 based on a history of access requests by the UE 120 (e.g., determining a threshold number of access requests may be achieved by UE 120 with managed small cells over a period of time), receiving an indication of the high mobility from a small cell managed by central controller 130, and/or the like. For example, the access requests can be admission control requests, handover requests, etc., for the UE 120. In this case, central controller 130 can inform a plurality of the managed small cells 106, 108, 110, 112, and/or 114 that UE 120 is high mobility (e.g., and/or that access for this UE 120 should be blocked) in a blocking message. Moreover, central controller 130 can notify one or more additional central controllers of the high mobility UE 120 in a blocking message. In one example, this can include informing other central controllers of different small cell networks (e.g., a WiFi small cell network where central controller 130 belongs to a cellular network, and/or vice versa).

In another example, a small cell, such as small cell 110, can detect high mobility of UE 120 based on a number of access requests received for UE 120 over a period of time. In this example, small cell 110 can notify central controller 130 of the high mobility UE 120 in a blocking message. In another example, small cell 110 can notify neighboring small cells that UE 120 is high mobility in a blocking message. For example, small cell 110 can notify small cells with which it shares a handover boundary (e.g., based on a history of cells to/from which small cell 110 has handed over UEs, local signal scanning, receiving the information from one or more network nodes, etc.). The neighboring small cells can report the blocking message out as well, and so on, allowing the blocking message to propagate throughout the small cell network. The small cell 110 can also block access requests of UE 120. In some designs, blocking messages for UE 120 can include an expiration time, after which access can be granted for UE 120.

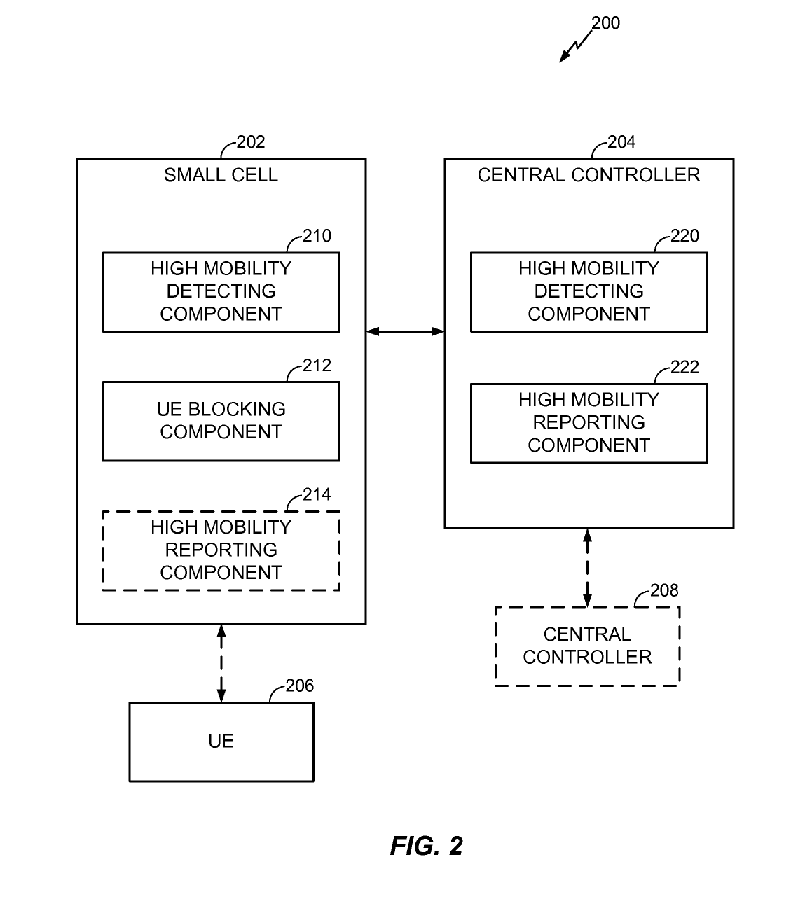

Referring to FIG. 2, an example wireless communication system 200 is illustrated that facilitates detecting UEs that exhibit high mobility. System 200 comprises a small cell 202 that can be deployed in a wireless network and can provide one or more devices with access thereto. System 200 also includes a central controller 204 that can configure a plurality of small cells, such as small cell 202, for operating in the wireless network. System 200 includes a UE 206 that can operate at high mobility, and another optional central controller 208 that can be of the same or different type as central controller 204. Central controllers 204 and 208 can each be a femto gateway, a controller for managing WiFi hotspots, an internet gateway, and/or the like.

Small cell 202 can include a high mobility detecting component 210 for determining one or more UEs is a high mobility UE, a UE blocking component 212 for blocking access of the high mobility UE, and/or an optional high mobility reporting component 214 for notifying other small cells and/or central controllers of the high mobility UE.

Central controller 204 can include a high mobility detecting component 220 for determining one or more UEs is a high mobility UE, and a high mobility reporting component 222 for notifying small cells and/or other central controllers of the high mobility UE.

According to an example, UE 206 can be communicating in a wireless network near small cell 202. UE 206 can have handed over to or otherwise requested access from small cell 202 during a period of time. Small cell 202 can report access requests (e.g., admission control requests, handovers, etc.) to central controller 204. This can include leveraging central controller 204 to access the wireless network, and thus central controller 204 can track access requests related to the UE 206 in this regard. High mobility detecting component 220 can determine that UE 206 is a high mobility UE based in part on a number of access requests received for the UE 206 at small cells controlled by central controller 204 during a period of time. For example, where the number of access requests achieves a threshold among small cells controlled by central controller 204 (including small cell 202), high mobility detecting component 220 can determine the UE 206 is a high mobility UE.

In this example, high mobility reporting component 222 can report the high mobility UE to small cells controlled by central controller 204, such as small cell 202, in a blocking message. This can include reporting an identifier of the high mobility UE along with a minimum blocking duration during which small cell 202 is to block access requests from the high mobility UE 206. In another example, the minimum blocking duration can be configured at small cell 202 (e.g., by a wireless network component). High mobility detecting component 210 can receive the blocking message from central controller 204, and UE blocking component 212 can block the high mobility UE 206 for at least the minimum blocking duration. For example, UE blocking component 212 can identify access requests for the UE 206 based on determining an identifier in the report matches an identifier in the request. Once the minimum blocking duration expires, UE blocking component 212 can refrain from blocking UE 206, and can grant access requests from UE 206. In another example, where small cell 202 is currently communicating with UE 206 when the blocking message is received from central controller 204, UE blocking component 212 can cause handover of the high mobility UE 206 to a macro node.

High mobility reporting component 222 can similarly report high mobility UE 206 to additional central controllers, such as central controller 208. Central controller 208 can be of a similar type as central controller 204 and/or in a location near central controller 204. Central controllers 204 and 208 can communicate over a wired or wireless backhaul link via a core wireless network, in one example. In another example, central controller 208 can be of a different type, such as a WiFi or other internet gateway. In this case, central controller 204 can indicate the high mobility UE 206 to the central controller 208 in a blocking message over an internet protocol (IP) connection. In any case, the message can include similar information, such as an identifier of the high mobility UE 206, a minimum blocking duration, etc. Moreover, central controller 208 can further transmit the message to additional central controllers (not shown) to propagate the blocking message throughout a network of controllers.

In another example, small cell 202 can detect high mobility of UE 206. In this example, high mobility detecting component 210 can determine that UE 206 is a high mobility UE based on a number of access requests received therefrom over a period of time. Where the number achieves a threshold, for example, high mobility detecting component 210 can determine UE 206 is a high mobility UE. In this example, UE blocking component 212 can determine to block access requests for UE 206 for a minimum block duration, which can be determined by UE blocking component 212 (e.g., based on previous blocking of the UE 206 or another UE, blocking trends, etc.) or otherwise configured or received from a wireless network component.

In addition, high mobility reporting component 214 can report the high mobility UE 206 to one or more other small cells (not shown) in a blocking message. For example, high mobility reporting component 214 can report to neighboring small cells with which small cell 202 has a handover boundary. In one example, small cell 202 can determine these small cells based on a handover history of UEs to/from small cell 202, a list received from central controller 204, and/or the like. Thus, once identified, the high mobility reporting component 214 can send the blocking message over a wired or wireless backhaul link thereto. For example, the report can include an identifier of the high mobility UE 206, a minimum blocking duration, an identifier of small cell 202, etc.

The neighboring small cells can be similarly equipped as small cell 202. Thus a high mobility detecting component of the neighboring small cells can receive the blocking message, a UE blocking component thereof can block the UE 206 for at least the minimum blocking duration, and/or a high mobility reporting component 214 can further report the high mobility UE 206 to additional neighboring cells thereof to propagate the blocking message throughout a small cell network. In another example, where small cell 202 does not ascertain neighboring small cells, high mobility reporting component 214 can broadcast the blocking message over the air, and nearby cells that can hear the report can receive the blocking message, block high mobility UE 206, and/or additionally broadcast the blocking message for receipt by their own nearby cells to propagate the message. In either case, all messages can have the same minimum blocking duration, which can be an absolute time such that blocking expires at all cells for the high mobility UE 206 at the same time.

In yet another example, high mobility reporting component 214 can report the high mobility UE 206 to central controller 204. In this example, high mobility detecting component 220 can receive the blocking message, and high mobility reporting component 222 can report the high mobility UE 206 to small cells configured by central controller 204 and/or to other central controllers 208, as described above.

To save signaling, in one example, high mobility reporting components 214 and 222 can report only high mobility UEs that currently have traffic and available macro cell service. Moreover, where small cell 202 sends blocking messages to other small cells, the other small cells can forward the message without forwarding the message back to small cell 202.

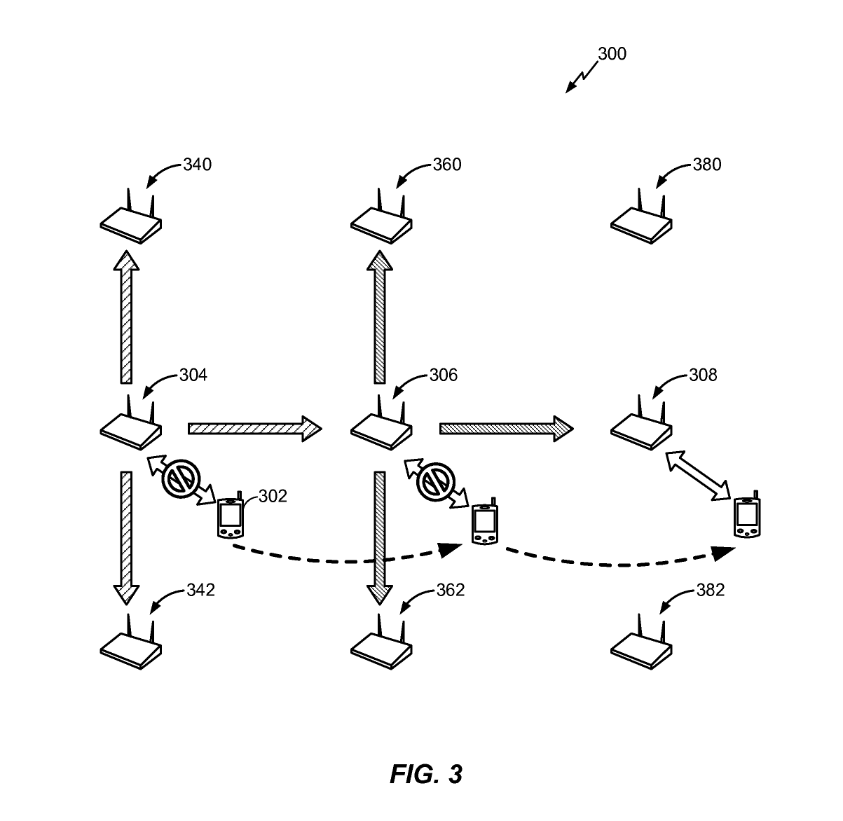

FIG. 3 illustrates an example system 300 for small cell cooperation in reporting a high mobility UE. In this example, a high mobility UE 302 moves from small cell 304, to small cell 306, to small cell 308. Small cell 304 initially detects the high mobility UE 302, blocks service (e.g., access requests, admission control request, handover, etc.) of the high mobility UE 302, and sends a blocking message to neighboring small cells (shaded arrows) 306, 340, and 342. The high mobility UE 302 then moves to small cell 306 and requests access. Due to the previously received blocking message, small cell 306 rejects admission of high mobility UE 302, and further forwards the blocking message to neighboring small cells (separately shaded arrows) 308, 360, and 362. Thus, the blocking message propagates along the user mobility route until the message expires. In this example, the message expires before or as the UE 302 moves to small cell 308, which stops blocking and does not forward the blocking message (e.g., to neighboring small cells 380 and/or 382).

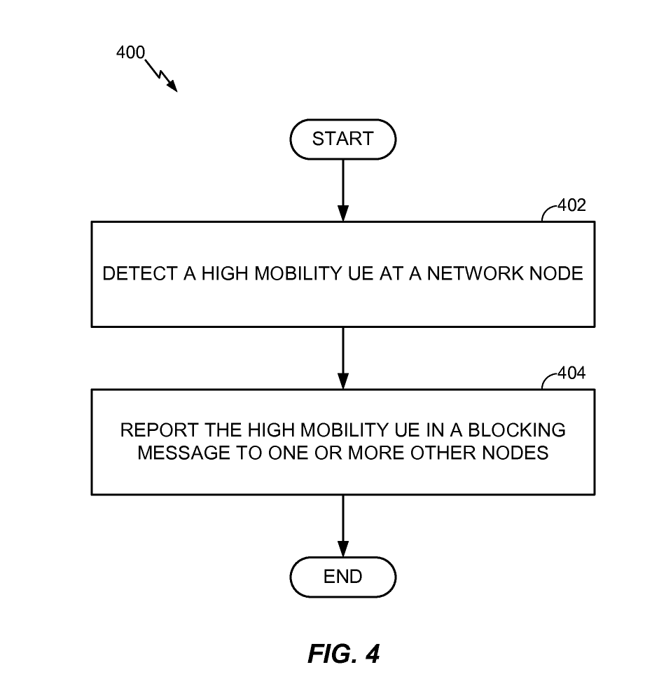

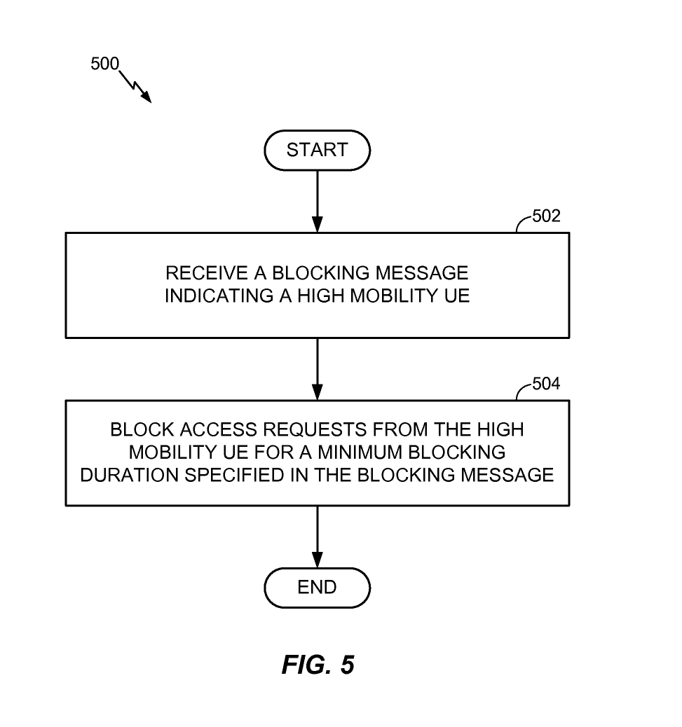

FIGS. 4-5 illustrate example methodologies relating to detecting and reporting high mobility UEs. While, for purposes of simplicity of explanation, the methodologies are shown and described as a series of acts, it is to be understood and appreciated that the methodologies are not limited by the order of acts, as some acts may, in accordance with one or more embodiments, occur concurrently with other acts and/or in different orders from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

FIG. 4 depicts an example methodology 400 for detecting a high mobility UE. In one example, the methodology 400 can be performed by a small cell 202, central controller 204, or related components, processors, etc.

At 402, a high mobility UE can be detected (e.g., based on a number of access requests from the UE at one or more small cells over a period of time). For example, the number of access requests can be detected for one or more small cells managed by a central controller. In another example, the small cell can detect the number of access requests. In yet another example, the high mobility UE can be detected based on a received blocking message from a small cell or central controller.

At 404, the high mobility UE can be reported in a blocking message to one or more access points. This can include transmitting the blocking message to one or more small cells managed by a central controller, transmitting the message to a central controller in a same or different network, transmitting the message to one or more neighboring small cells (e.g., small cells sharing a handover boundary) and/or the like. Moreover, the blocking message can identify the high mobility UE, a minimum blocking duration for blocking access requests from the UE, an identifier of the small cell transmitting the blocking message, and/or the like.

FIG. 5 illustrates an example methodology 500 for blocking access requests of a high mobility UE. In one example, the methodology 500 can be performed by a small cell 202, or related components, processors, etc.

At 502, a blocking message indicating a high mobility UE can be received. For example, the blocking message can be received from a central controller, one or more small cells, and/or the like. The blocking message can include an identifier of the high mobility UE, a minimum blocking duration during which to block the UE, an identifier of a small cell transmitting the blocking message (e.g., to avoid forwarding the message back to the small cell), and/or the like.

At 504, access requests from the high mobility UE can be blocked for a minimum blocking duration specified in the blocking message. For example, the blocked access requests can include admission requests, handover requests, etc. Once the duration is complete, access requests can be accepted from the UE.

It will be appreciated that, in accordance with one or more aspects described herein, inferences can be made regarding determining whether to block a UE, a minimum blocking duration, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

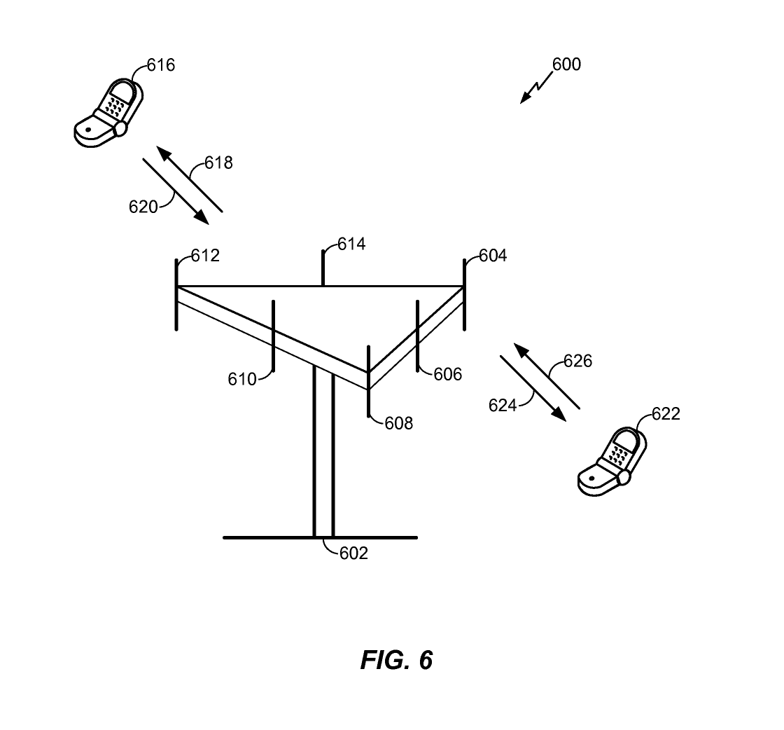

FIG. 6 illustrates a wireless communication system 600 in accordance with various embodiments presented herein. Wireless communication system 600 comprises a base station 602 that can include multiple antenna groups. For example, one antenna group can include antennas 604 and 606, another group can comprise antennas 608 and 610, and an additional group can include antennas 612 and 614. Two antennas are illustrated for each antenna group; however, more or fewer antennas can be utilized for each group. Base station 602 can additionally include a transmitter chain and a receiver chain, each of which can in turn comprise a plurality of components or modules associated with signal transmission and reception (e.g., processors, modulators, multiplexers, demodulators, demultiplexers, antennas, etc.), as will be appreciated.

Base station 602 can communicate with one or more mobile devices such as mobile device 616 and mobile device 622; however, it is to be appreciated that base station 602 can communicate with substantially any number of mobile devices similar to mobile devices 616 and 622. Mobile devices 616 and 622 can be, for example, cellular phones, smart phones, laptops, handheld communication devices, handheld computing devices, satellite radios, global positioning systems, PDAs, and/or any other suitable device for communicating over wireless communication system 600. As depicted, mobile device 616 is in communication with antennas 612 and 614, where antennas 612 and 614 transmit information to mobile device 616 over a forward link 618 and receive information from mobile device 616 over a reverse link 620. Moreover, mobile device 622 is in communication with antennas 604 and 606, where antennas 604 and 606 transmit information to mobile device 622 over a forward link 624 and receive information from mobile device 622 over a reverse link 626. In a frequency division duplex (FDD) system, forward link 618 can utilize a different frequency band than that used by reverse link 620, and forward link 624 can employ a different frequency band than that employed by reverse link 626, for example. Further, in a time division duplex (TDD) system, forward link 618 and reverse link 620 can utilize a common frequency band and forward link 624 and reverse link 626 can utilize a common frequency band.

Each group of antennas and/or the area in which they are designated to communicate can be referred to as a sector of base station 602. For example, antenna groups can be designed to communicate to mobile devices in a sector of the areas covered by base station 602. In communication over forward links 618 and 624, the transmitting antennas of base station 602 can utilize beamforming to improve signal-to-noise ratio of forward links 618 and 624 for mobile devices 616 and 622. Also, while base station 602 utilizes beamforming to transmit to mobile devices 616 and 622 scattered randomly through an associated coverage, mobile devices in neighboring cells can be subject to less interference as compared to a base station transmitting through a single antenna to all its mobile devices. Moreover, mobile devices 616 and 622 can communicate directly with one another using a peer-to-peer or ad hoc technology as described.

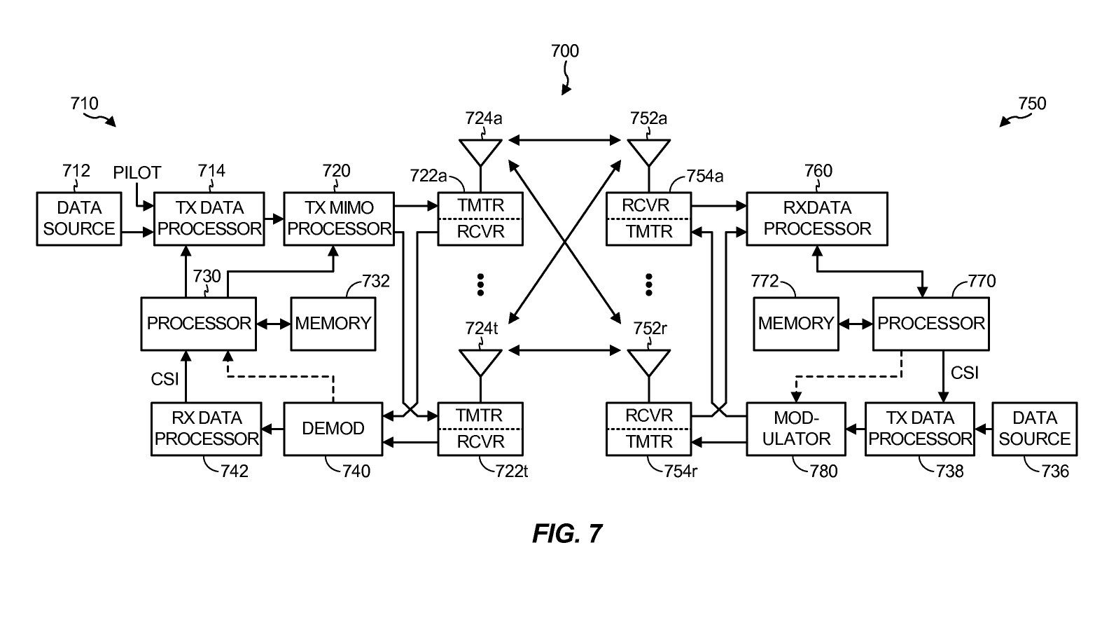

FIG. 7 shows an example wireless communication system 700. The wireless communication system 700 depicts one base station 710 and one mobile device 750 for sake of brevity. However, it is to be appreciated that wireless communication system 700 can include more than one base station and/or more than one mobile device, wherein additional base stations and/or mobile devices can be substantially similar or different from example base station 710 and mobile device 750 described below. Moreover, base station 710 can be a low power base station, in one example, such as one or more femto nodes previously described. In addition, it is to be appreciated that base station 710 and/or mobile device 750 can employ the example systems (FIGS. 1-3 and 6) and/or methods (FIGS. 4-5) described herein to facilitate wireless communication therebetween. For example, components or functions of the systems and/or methods described herein can be part of a memory 732 and/or 772 or processors 730 and/or 770 described below, and/or can be executed by processors 730 and/or 770 to perform the disclosed functions.

At base station 710, traffic data for a number of data streams is provided from a data source 712 to a transmit (TX) data processor 714. According to an example, each data stream can be transmitted over a respective antenna. TX data processor 714 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 750 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 730.

The modulation symbols for the data streams can be provided to a TX MIMO processor 720, which can further process the modulation symbols (e.g., for OFDM). TX MIMO processor 720 then provides NT modulation symbol streams to NT transmitters (TMTR) 722a through 722t. In various embodiments, TX MIMO processor 720 applies beamforming weights to the symbols of the data streams and to the antenna from which the symbol is being transmitted.

Each transmitter 722a through 722t receives and processes a respective symbol stream to provide one or more analog signals, and further conditions (e.g., amplifies, filters, and upconverts) the analog signals to provide a modulated signal suitable for transmission over the MIMO channel. Further, NT modulated signals from the transmitters 722a through 722t are transmitted from NT antennas 724a through 724t, respectively.

At mobile device 750, the transmitted modulated signals are received by NR antennas 752a through 752r and the received signal from each antenna 752a through 752r is provided to a respective receiver (RCVR) 754a through 754r. Each receiver 754a through 754r conditions (e.g., filters, amplifies, and downconverts) a respective signal, digitizes the conditioned signal to provide samples, and further processes the samples to provide a corresponding “received” symbol stream.

An RX data processor 760 can receive and process the NR received symbol streams from the NR receivers 754a through 754r based on a particular receiver processing technique to provide NT “detected” symbol streams. RX data processor 760 can demodulate, deinterleave, and decode each detected symbol stream to recover the traffic data for the data stream. The processing by RX data processor 760 is complementary to that performed by TX MIMO processor 720 and TX data processor 714 at base station 710.

The reverse link message can comprise various types of information regarding the communication link and/or the received data stream. The reverse link message can be processed by a TX data processor 738, which also receives traffic data for a number of data streams from a data source 736, modulated by a modulator 780, conditioned by transmitters 754a through 754r, and transmitted back to base station 710.

At base station 710, the modulated signals from mobile device 750 are received by antennas 724, conditioned by receivers 722a through 722t, demodulated by a demodulator 740, and processed by a RX data processor 742 to extract the reverse link message transmitted by mobile device 750. Further, processor 730 can process the extracted message to determine which precoding matrix to use for determining the beamforming weights.

Processors 730 and 770 can direct (e.g., control, coordinate, manage, etc.) operation at base station 710 and mobile device 750, respectively. Respective processors 730 and 770 can be associated with memory 732 and 772 that store program codes and data. For example, processor 730 and/or 770 can execute, and/or memory 732 and/or 772 can store instructions related to functions and/or components described herein, such as detect, reporting, and blocking high mobility UEs, and/or the like, as described.

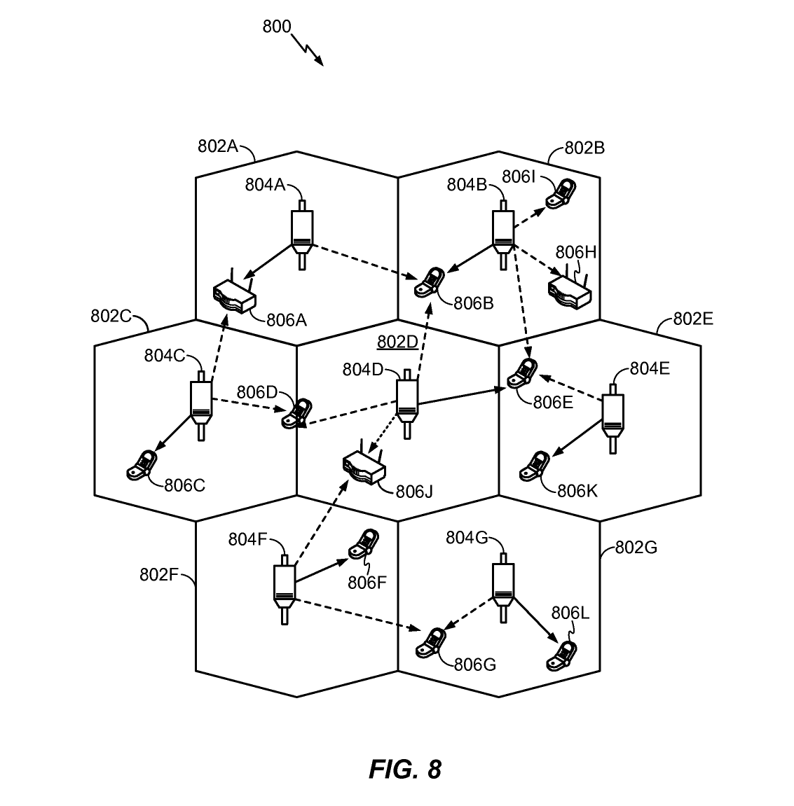

FIG. 8 illustrates a wireless communication system 800, configured to support a number of users, in which the embodiments and teachings herein may be implemented. The wireless communication system 800 provides communication for multiple cells 802, such as, for example, macro cells 802A-802G, with each cell being serviced by a corresponding access node 804 (e.g., access nodes 804A-804G). As shown in FIG. 8, access terminals 806 (e.g., access terminals 806A-806L) can be dispersed at various locations throughout the system over time. Each access terminal 806 can communicate with one or more access nodes 804 on a forward link (FL) and/or a reverse link (RL) at a given moment, depending upon whether the access terminal 806 is active and whether it is in soft handoff, for example. The wireless communication system 800 can provide service over a large geographic region.

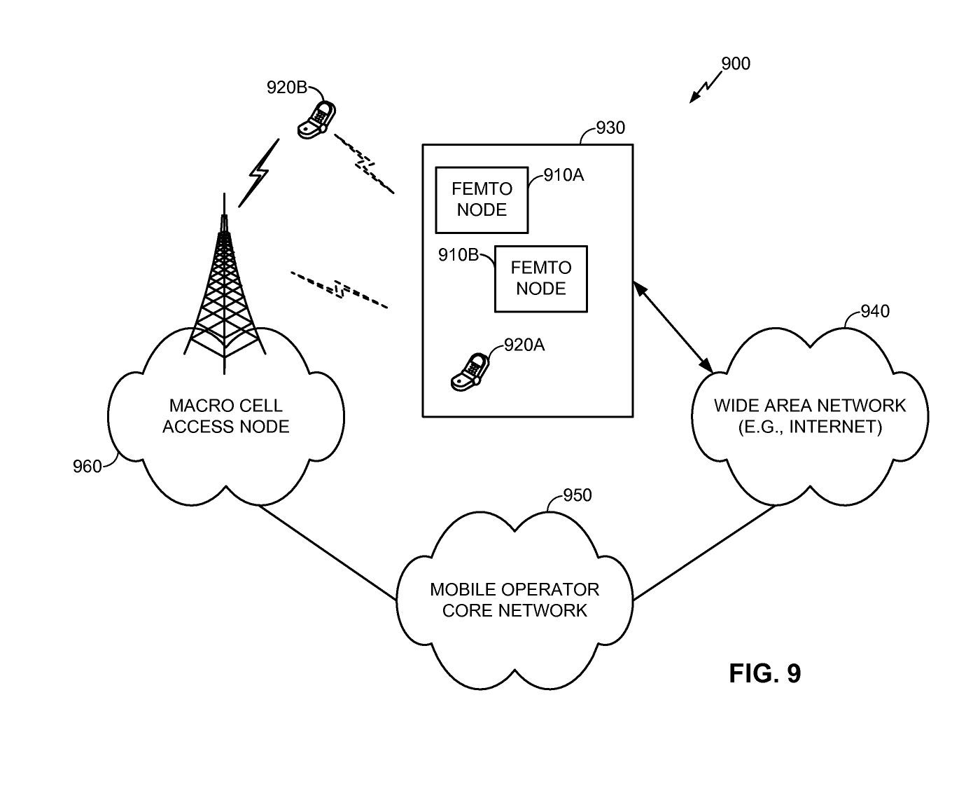

FIG. 9 illustrates an exemplary communication system 900 where one or more femto nodes are deployed within a network environment. Specifically, the system 900 includes multiple femto nodes 910A and 910B (e.g., femtocell nodes or H(e)NB) installed in a relatively small scale network environment (e.g., in one or more user residences 930). Each femto node 910 can be coupled to a wide area network 940 (e.g., the Internet) and a mobile operator core network 950 via a digital subscriber line (DSL) router, a cable modem, a wireless link, or other connectivity means (not shown). As will be discussed below, each femto node 910 can be configured to serve associated access terminals 920 (e.g., access terminal 920A) and, optionally, alien access terminals 920 (e.g., access terminal 920B). In other words, access to femto nodes 910 can be restricted such that a given access terminal 920 can be served by a set of designated (e.g., home) femto node(s) 910 but may not be served by any non-designated femto nodes 910 (e.g., a neighbor's femto node).

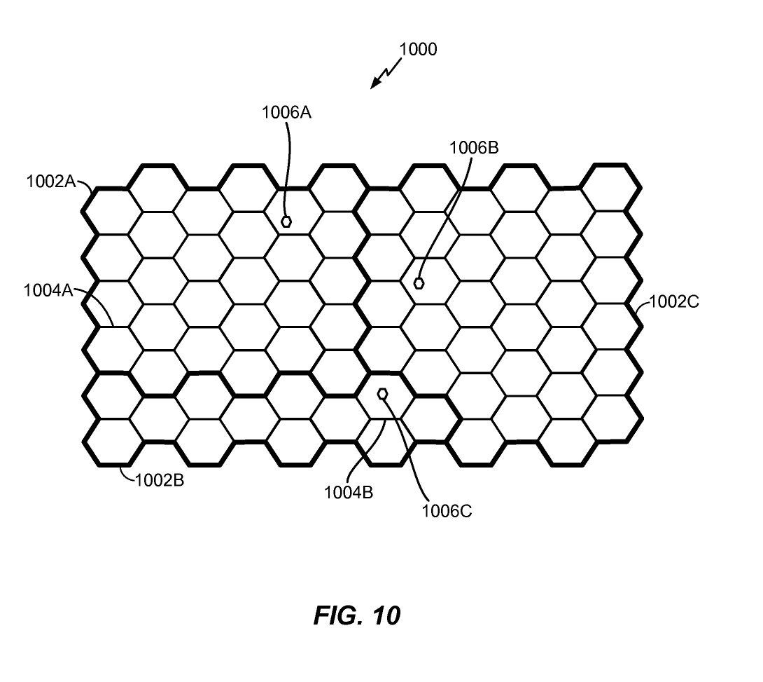

FIG. 10 illustrates an example of a coverage map 1000 where several tracking areas 1002 (or routing areas or location areas) are defined, each of which includes several macro coverage areas 1004. Here, areas of coverage associated with tracking areas 1002A, 1002B, and 1002C are delineated by the wide lines and the macro coverage areas 1004 are represented by the hexagons. The tracking areas 1002 also include femto coverage areas 1006. In this example, each of the femto coverage areas 1006 (e.g., femto coverage area 1006C) is depicted within a macro coverage area 1004 (e.g., macro coverage area 1004B). It should be appreciated, however, that a femto coverage area 1006 may not lie entirely within a macro coverage area 1004. In practice, a large number of femto coverage areas 1006 can be defined with a given tracking area 1002 or macro coverage area 1004. Also, one or more pico coverage areas (not shown) can be defined within a given tracking area 1002 or macro coverage area 1004.

Referring again to FIG. 9, the owner of a femto node 910 can subscribe to mobile service, such as, for example, 3G mobile service, offered through the mobile operator core network 950. In addition, an access terminal 920 can be capable of operating both in macro environments and in smaller scale (e.g., residential) network environments. Thus, for example, depending on the current location of the access terminal 920, the access terminal 920 can be served by an access node 960 or by any one of a set of femto nodes 910 (e.g., the femto nodes 910A and 910B that reside within a corresponding user residence 930). For example, when a subscriber is outside his home, he is served by a standard macro cell access node (e.g., node 960) and when the subscriber is at home, he is served by a femto node (e.g., node 910A). Here, it should be appreciated that a femto node 910 can be backward compatible with existing access terminals 920.

A femto node 910 can be deployed on a single frequency or, in the alternative, on multiple frequencies. Depending on the particular configuration, the single frequency or one or more of the multiple frequencies can overlap with one or more frequencies used by a macro cell access node (e.g., node 960). In some aspects, an access terminal 920 can be configured to connect to a preferred femto node (e.g., the home femto node of the access terminal 920) whenever such connectivity is possible. For example, whenever the access terminal 920 is within the user's residence 930, it can communicate with the home femto node 910.

In some aspects, if the access terminal 920 operates within the mobile operator core network 950 but is not residing on its most preferred network (e.g., as defined in a preferred roaming list), the access terminal 920 can continue to search for the most preferred network (e.g., femto node 910) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the access terminal 920 can limit the search for specific band and channel. For example, the search for the most preferred system can be repeated periodically. Upon discovery of a preferred femto node, such as femto node 910, the access terminal 920 selects the femto node 910 for camping within its coverage area.

A femto node can be restricted in some aspects. For example, a given femto node can only provide certain services to certain access terminals. In deployments with so-called restricted (or closed) association, a given access terminal can only be served by the macro cell mobile network and a defined set of femto nodes (e.g., the femto nodes 910 that reside within the corresponding user residence 930). In some implementations, a femto node can be restricted to not provide, for at least one access terminal, at least one of: signaling, data access, registration, paging, or service.

In some aspects, a restricted femto node (which can also be referred to as a Closed Subscriber Group H(e)NB) is one that provides service to a restricted provisioned set of access terminals. This set can be temporarily or permanently extended as necessary. In some aspects, a Closed Subscriber Group (CSG) can be defined as the set of access nodes (e.g., femto nodes) that share a common access control list of access terminals. A channel on which all femto nodes (or all restricted femto nodes) in a region operate can be referred to as a femto channel.

Various relationships can thus exist between a given femto node and a given access terminal. For example, from the perspective of an access terminal, an open femto node can refer to a femto node with no restricted association. A restricted femto node can refer to a femto node that is restricted in some manner (e.g., restricted for association and/or registration). A home femto node can refer to a femto node on which the access terminal is authorized to access and operate on. A guest femto node can refer to a femto node on which an access terminal is temporarily authorized to access or operate on. An alien femto node can refer to a femto node on which the access terminal is not authorized to access or operate on (e.g., the access terminal is a non-member), except for perhaps emergency situations (e.g., 911 calls).

From a restricted femto node perspective, a home access terminal can refer to an access terminal that is authorized to access the restricted femto node. A guest access terminal can refer to an access terminal with temporary access to the restricted femto node. An alien access terminal can refer to an access terminal that does not have permission to access the restricted femto node, except for perhaps emergency situations, for example, 911 calls (e.g., an access terminal that does not have the credentials or permission to register with the restricted femto node).

For convenience, the disclosure herein describes various functionality in the context of a femto node. It should be appreciated, however, that a pico node can provide the same or similar functionality as a femto node, but for a larger coverage area. For example, a pico node can be restricted, a home pico node can be defined for a given access terminal, and so on.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

1. A method for reporting high mobility user equipment (UE) in a wireless network, comprising:
detecting a high mobility UE at a network node; and
reporting the high mobility UE in a blocking message to one or more other network nodes.

2. The method of claim 1, wherein the network node comprises (i) one or more small cells or (ii) one or more central controllers managing the one or more small cells.

3. The method of claim 2, further comprising identifying the one or more small cells from previous handovers, local signal scanning, or neighboring cell information received from other network nodes.

4. The method of claim 2, further comprising identifying the one or more central controllers from previous handovers or neighboring central controller information received from other network nodes.

5. The method of claim 1, wherein the blocking message comprises a minimum blocking duration over which to block access requests from the high mobility UE.

6. The method of claim 1, further comprising granting an access request from the UE after a minimum blocking duration specified in the blocking message when a mobility state of the UE is other than a high mobility state.

7. The method of claim 1, wherein the one or more other network nodes operate in the same wireless network as a wireless network receiving high mobility UE access requests.

8. The method of claim 1, wherein the one or more other network nodes operate in one or more different wireless networks from a wireless network receiving high mobility UE access requests.

9. The method of claim 8, wherein the blocking message identifies the UE by an identifier specified in a format corresponding to the network that receives the blocking message.

10. The method of claim 1, wherein detecting the high mobility UE is based on access requests from the UE at a plurality of small cells over a period of time.

11. The method of claim 1, wherein detecting the high mobility UE comprises receiving a blocking message that identifies the UE from one or more other network nodes.

12. An apparatus for reporting high mobility user equipment (UE) in a wireless network, comprising:
at least one processor configured to detect a high mobility UE at a network node and to report the high mobility UE in a blocking message to one or more other network nodes; and
memory coupled to the at least one processor.

13. The apparatus of claim 12, wherein the network node comprises (i) one or more small cells or (ii) one or more central controllers managing the one or more small cells.

14. The apparatus of claim 13, wherein the at least one processor is further configured to identify the one or more small cells from previous handovers, local signal scanning, or neighboring cell information received from other network nodes.

15. The apparatus of claim 13, wherein the at least one processor is further configured to identify the one or more central controllers from previous handovers or neighboring central controller information received from other network nodes.

16. The apparatus of claim 12, wherein the blocking message comprises a minimum blocking duration over which to block access requests from the high mobility UE.

17. The apparatus of claim 12, wherein the at least one processor is further configured to grant an access request from the UE after a minimum blocking duration specified in the blocking message when a mobility state of the UE is other than a high mobility state.

18. The apparatus of claim 12, wherein the one or more other network nodes operate in the same wireless network as a wireless network receiving high mobility UE access requests.

19. The apparatus of claim 12, wherein the one or more other network nodes operate in one or more different wireless networks from a wireless network receiving high mobility UE access requests.

20. The apparatus of claim 19, wherein the blocking message identifies the UE by an identifier specified in a format corresponding to the network that receives the blocking message.

21. The apparatus of claim 12, wherein the at least one processor is configured to detect the high mobility UE based on access requests from the UE at a plurality of small cells over a period of time.

22. The apparatus of claim 12, wherein the at least one processor is configured to detect the high mobility UE by receiving a blocking message that identifies the UE from one or more other network nodes.

23. An apparatus for reporting high mobility user equipment (UE) in a wireless network, comprising:
means for detecting a high mobility UE at a network node; and
means for reporting the high mobility UE in a blocking message to one or more other network nodes.

24. The apparatus of claim 23, wherein the network node comprises (i) one or more small cells or (ii) one or more central controllers managing the one or more small cells.

25. The apparatus of claim 24, further comprising means for identifying the one or more small cells from previous handovers, local signal scanning, or neighboring cell information received from other network nodes.

26. The apparatus of claim 24, further comprising means for identifying the one or more central controllers from previous handovers or neighboring central controller information received from other network nodes.

27. The apparatus of claim 23, wherein the blocking message comprises a minimum blocking duration over which to block access requests from the high mobility UE.

28. The apparatus of claim 23, further comprising means for granting an access request from the UE after a minimum blocking duration specified in the blocking message when a mobility state of the UE is other than a high mobility state.

29. The apparatus of claim 23, wherein the one or more other network nodes operate in the same wireless network as a wireless network receiving high mobility UE access requests.

30. The apparatus of claim 23, wherein the one or more other network nodes operate in one or more different wireless networks from a wireless network receiving high mobility UE access requests.

31. The apparatus of claim 30, wherein the blocking message identifies the UE by an identifier specified in a format corresponding to the network that receives the blocking message.

32. The apparatus of claim 23, wherein the means for detecting the high mobility UE comprises means for detecting the high mobility UE based on access requests from the UE at a plurality of small cells over a period of time.

33. The apparatus of claim 23, wherein the means for detecting the high mobility UE comprises means for receiving a blocking message that identifies the UE from one or more other network nodes.

34. A non-transitory computer-readable medium comprising code, which, when executed by a processor, causes the processor to perform operations for reporting high mobility user equipment (UE) in a wireless network, the non-transitory computer-readable medium comprising:
code for detecting a high mobility UE at a network node; and
code for reporting the high mobility UE in a blocking message to one or more other network nodes.

35. The non-transitory computer-readable medium of claim 34, wherein the network node comprises (i) one or more small cells or (ii) one or more central controllers managing the one or more small cells.

36. The non-transitory computer-readable medium of claim 35, further comprising code for identifying the one or more small cells from previous handovers, local signal scanning, or neighboring cell information received from other network nodes.

37. The non-transitory computer-readable medium of claim 35, further comprising code for identifying the one or more central controllers from previous handovers or neighboring central controller information received from other network nodes.

38. The non-transitory computer-readable medium of claim 34, wherein the blocking message comprises a minimum blocking duration over which to block access requests from the high mobility UE.

39. The non-transitory computer-readable medium of claim 34, further comprising code for granting an access request from the UE after a minimum blocking duration specified in the blocking message when a mobility state of the UE is other than a high mobility state.

40. The non-transitory computer-readable medium of claim 34, wherein the one or more other network nodes operate in the same wireless network as a wireless network receiving high mobility UE access requests.

41. The non-transitory computer-readable medium of claim 34, wherein the one or more other network nodes operate in one or more different wireless networks from a wireless network receiving high mobility UE access requests.

42. The non-transitory computer-readable medium of claim 41, wherein the blocking message identifies the UE by an identifier specified in a format corresponding to the network that receives the blocking message.

43. The non-transitory computer-readable medium of claim 34, wherein the code for detecting the high mobility UE comprises code for detecting the high mobility UE based on access requests from the UE at a plurality of small cells over a period of time.

44. The non-transitory computer-readable medium of claim 34, wherein the code for detecting the high mobility UE comprises code for receiving a blocking message that identifies the UE from one or more other network nodes.
